(19) United States
(12) Patent Application Publication
(10) Pub. No.: US 2025/0139129 A1
(43) Pub. Date: May 1, 2025

(54) METHOD, APPARATUS, DEVICE AND STORAGE MEDIUM FOR ASSISTING IN BOOK CREATION

(71) Applicant: Beijing Zitiao Network Technology Co., Ltd., Beijing (CN)

(72) Inventor: Yan YANG, Beijing (CN)

(21) Appl. No.: 18/793,521

(22) Filed: Aug. 2, 2024

(30) Foreign Application Priority Data
Oct. 27, 2023 (CN) 202311415584.4

(51) Int. Cl. G06F 16/28

(52) U.S. Cl. CPC G06F 16/285

(57) ABSTRACT

According to the embodiments of the disclosure, a method, an apparatus, a device and storage medium for assisting in book creation are provided. The method includes: obtaining a set of topic contents associated with a book content; extracting a first set of keywords from the set of topic contents, the first set of keywords being associated with a creation theme of the book; and providing the first set of keywords and corresponding topic information, the topic information indicating a topic content in the set of topic contents that matches a corresponding keyword. As such, the embodiments of the disclosure can provide users with topic content corresponding to the keyword to assist in creation of books, thereby improving the creation efficiency of the creator.

### CROSS REFERENCE

This application claims priority of the Chinese patent application No. 202311415584.4, entitled “METHOD, APPARATUS, DEVICE AND STORAGE MEDIUM FOR ASSISTING IN BOOK CREATION” filed on Oct. 27, 2023, the entire content of which is incorporated herein by reference.

### FIELD

Example embodiments of the present disclosure generally relate to the field of computers, and in particular, to methods, apparatuses, devices, and computer-readable storage media for assisting in book creation.

### BACKGROUND

With the rapid development of media technologies and smart devices, some creators may create and share works through the Internet. Users may obtain such a work through a web page or an application, and perform various types of interactions with the creator, for example, subscription, reviewing, sharing, and the like.

Therefore, for the creator, the creator expects to know the user's needs in time and perform targeted creation.

### SUMMARY

In a first aspect of the present disclosure, a method of assisting in book creation is provided. The method comprises: obtaining a set of topic contents associated with a book content; extracting a first set of keywords from the set of topic contents, the first set of keywords being associated with a creation theme of the book; and providing the first set of keywords and corresponding topic information, the topic information indicating a topic content in the set of topic contents that matches a corresponding keyword.

In a second aspect of the present disclosure, an apparatus for assisting in book creation is provided. The apparatus comprises: an obtaining module configured to obtain a set of topic contents associated with a book content; an extraction module configured to extract a first set of keywords from the set of topic contents, the first set of keywords being associated with a creation theme of the book; and a provision module configured to provide the first set of keywords and corresponding topic information, the topic information indicating a topic content in the set of topic contents that matches a corresponding keyword.

In a third aspect of the present disclosure, an electronic device is provided. The device comprises at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the

present disclosure will become more apparent from the following detailed description taken in connection with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2A to FIG. 2D illustrate example interfaces in accordance with some embodiments of the present disclosure;

FIG. 3A and FIG. 3B illustrate example interfaces according to another embodiment of the present disclosure;

FIG. 4 illustrates a flowchart of an example process for assisting in creation of a book according to some embodiments of the present disclosure;

FIG. 5 illustrates a block diagram of an apparatus for assisting in creation of a book according to some embodiments of the present disclosure; and

FIG. 6 illustrates a block diagram of an electronic device capable of implementing various embodiments of the present disclosure.

### DETAILED DESCRIPTION

It can be understood that before using the technical solutions disclosed in each embodiment of the present disclosure, relevant user should be informed of the types, use ranges, usage scenarios, and the like of the personal information related to the present disclosure in an appropriate manner according to relevant laws and regulations, and the authorization of the related user may be obtained.

For example, in response to receiving an active request from a user, prompt information is sent to the user to explicitly prompt the user that the requested operation will need to obtain and use the personal information of the user. Therefore, the user can autonomously select whether to provide personal information to software or hardware such as electronic device, application, server or storage medium and etc., executing the operation of the technical solution of the present disclosure according to the prompt information.

As an optional but non-limiting implementation, in response to receiving an active request of a user, a manner of sending prompt information to the user may be, for example, a pop-up window, and prompt information may be presented in a text manner in the pop-up window. In addition, the pop-up window may further carry a selection control for the user to select “agree” or “not agree” to provide information to the electronic device.

It may be understood that the foregoing notification and obtaining a user authorization process are merely illustrative, and do not constitute a limitation on implementations of the present disclosure, and other manners of meeting related laws and regulations may also be applied to implementations of the present disclosure.

It may be understood that the data involved in the technical solution (including but not limited to the data itself, the obtain or use of the data) should follow the requirements of the corresponding laws and regulations and related regulations.

The term “in response to” as used herein means a state in which a respective event occurs or a condition is satisfied. It will be appreciated that the timing of execution of a subsequent action performed in response to the event or condition is not necessarily strongly correlated with the time at which the event occurs or the condition holds. For example, in some scenarios, a subsequent action may be performed immediately when an event occurs or a condition holds; while in other scenarios, a subsequent action may be performed after a period of time elapses after an event occurs or a condition holds.

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the headline of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in a different section/subsection.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definition may also be included below. The terms “first,” “second,” and the like may refer to different or identical object. Other explicit and implicit definition may also be included below.

As used herein, a “unit,” an “operating unit,” or a “subunit” may be composed of a machine learning model or network of any suitable structure. As used herein, a set of elements or similar expressions may include one or more such elements. For example, a “set of convolution units” may include one or more convolution units.

As mentioned briefly above, according to a traditional approach, it is desirable for the reader to be able to obtain a particular theme related work. For a creator, how to more timely and efficiently understand the requirement to current work of the user is desired by the creator.

Therefore, embodiments of the present disclosure provide a solution for assisting in book creation. According to various embodiments of the present disclosure, a set of topic contents associated with the book content may be obtained; further, a first set of keywords may be extracted from a set of topic contents, wherein the first set of keywords is associated with a creation theme of the book. Correspondingly, the first set of keywords and the corresponding topic information may be provided, and the topic information is used to indicate the topic content in the set of topic contents that matches the corresponding keyword.

Therefore, the embodiment of the disclosure can provide the topic content corresponding to the keyword for the user (for example, the book creator) to assist in the creation of the book (for example, the electronic book), so that the book creation efficiency of the creator can be improved.

Example embodiments of the present disclosure are described below with reference to the accompanying drawings.

### Example Environment

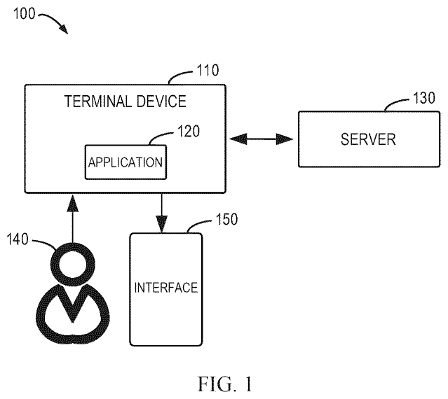

FIG. 1 illustrates a schematic diagram of an example environment 100 in which embodiments of the present disclosure can be implemented. In the environment 100, an application 120 is installed in the terminal device 110. The user 140 may interact with the application 120 via the terminal device 110 and/or an attached device of the terminal device 110. The application 120 may be a work sharing application, a play tool type application, a social type application, or any other suitable application. The application 120 can provide services related to viewing, creation, and management of the work to the user 140. In the present disclosure, a work may include a text type work such as an electronic book or an article, or a media type work such as an audio book or a video.

In environment 100 of FIG. 1, if the application 120 is in an active state, the terminal device 110 may present interface 150 of application 120. The interface 150 may include various interfaces that can be provided by the application 120. The application 120 may also be a browser, and the user 140 may access a corresponding website through a browser to obtain a corresponding interface 150.

It should be understood that although the application 120 is shown as being included in the terminal device 110 in FIG. 1, a part of the processing capability of the application 120 may also be, for example, based at least in part on the server 130.

In some embodiments, terminal device 110 communicates with server 130 to enable the provision of the service to application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interfaces for a user (such as a “wearable” circuit, etc.). The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described for illustrative purposes only and do not imply any limitation to the scope of the present disclosure.

Some example embodiments of the present disclosure will be described below with continued reference to the accompanying drawings.

### Example Interface

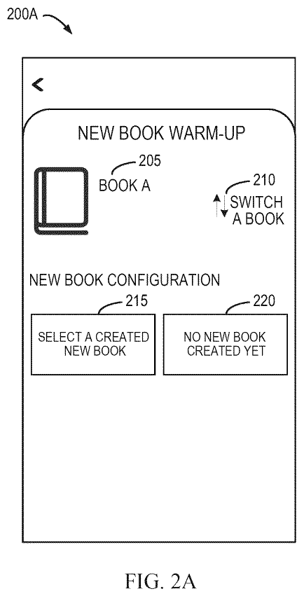

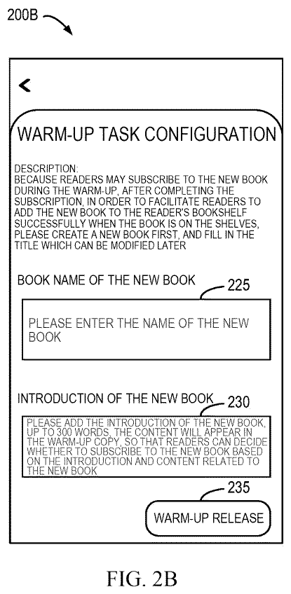

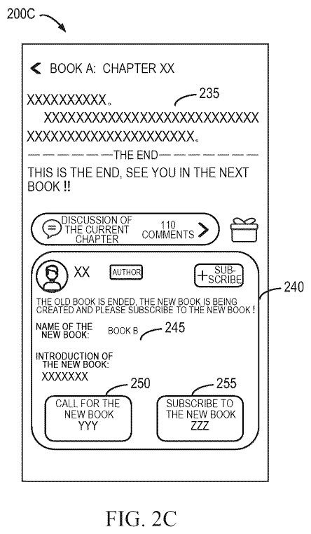

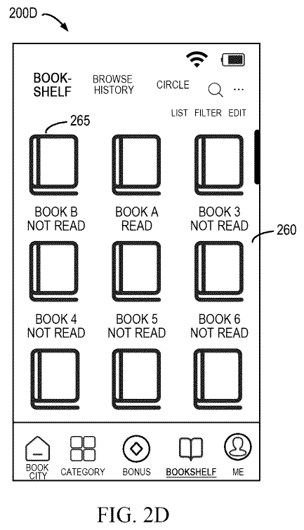

FIG. 2A to FIG. 2D illustrate example interfaces in accordance with some embodiments of the present disclosure. The interfaces of FIG. 2A to FIG. 2D may be provided, for example, by the terminal device 110 shown in FIG. 1. For ease of description, embodiments of the present disclosure are described below with books as examples of works, but it should be understood that this is for convenience of description only. As discussed above, a work may include a text type work such as an electronic book or an article, or a media type work such as an audiobook or a video.

As shown in FIG. 2A, the terminal device 110 associated with the creator (e.g., the creator of the book) may present the interface 200A shown in FIG. 2A for the creator. Such an interface 200A may, for example, be referred to as a new book guidance page for configuring unreleased books.

In some embodiments, the terminal device 110 may provide an interface 200A for configuring the unreleased book for the creator only when the created content of the current book of the creator exceeds a threshold. For example, taking FIG. 2A as an example, the terminal device 110 may provide the interface 200A shown in FIG. 2A for the creator to guide the creator to configure the new book when the number of words “book A” currently updated by the creator exceeds the threshold number.

For example, as shown in FIG. 2A, the terminal device 110 may present a book 205 (also referred to as a target book, for example, book A) that has been released by the creator, to prompt that the related content of the created new book is presented in association with the book 205.

In some embodiments, the book 205 is selected from, for example, released books by a creator. Alternatively, the book 205 may be determined from a set of books that have been released by the creator based on a predetermined condition, and the predetermined condition includes a completion status of the book and/or an amount of content that has been created for the book. For example, a book having an amount of created content greater than a threshold and still in an updating status may be selected as the target book.

In some embodiments, the terminal device 110 may further provide a modification control 210 for selecting a book from the released books by the creator for associatively presenting related content of the new book that has not been created.

In some embodiments, the terminal device 110 may provide a selection control 215 in the interface 200A for selecting one book from the unreleased books by the creator. For example, the creator may have created but not yet release a set of books, and accordingly, the creator may select an unreleased book to be presented in association with the released book 205 from the set of books through selecting the control 215.

In some embodiments, the terminal device 110 may further provide a creation control 215 in the interface 200A. After receiving the selection of the creation control 215, the terminal device 110 may, for example, present the interface 200B shown in FIG. 2B. The interface 200B may also be referred to as a new book guidance page.

As shown in FIG. 2B, the terminal device 110 may provide, in the interface 200B, an input control 225 and/or an input control 230 for inputting description information of a not created book. The input control 225 may be used to receive an input of the creator about the book name of the book. Input controls 230 may be used to receive an input of a creator about a summary or introduction of the book. The book name and/or summary input by the creator may constitute the description information of the book.

In some embodiments, the creator may also edit such description information at a subsequent stage, for example. For example, the creator may modify the book name and/or summary of the book during the creation of the book.

As another example, for an example mentioned above for selecting one book from the created books, the description information of the book may be automatically determined, for example, based on the created content of the book, or the description information of the book may also direct the creator to perform editing and/or confirmation.

In some embodiments, in a scenario where the creator selects the release control 235, the terminal device 110 may control at least a portion of the description information associated with the unreleased new book to be presented in the viewing interface of the book 205.

FIG. 2C illustrates a viewing interface 200C of the book 205. Such a viewing interface 200C may, for example, be presented by a terminal device 110 associated with an creator and/or a reader-user.

As shown in FIG. 2C, the interface 200C may be used to obtain content of the book 205. In addition, the interface 200C may also include a target component 240 associated with the selected new book and/or the created new book (e.g., book B).

In some embodiments, the target component 240 may be presented in the viewing interface 200C of the most recently released content of the book 205. For example, the target component 240 may be presented at the end of the latest chapter of the book 205. Further, as shown in FIG. 2C, the target component 240 may be used to present at least

part 245 of the description information of the selected new book and/or the created new book (e.g., book B). For example, the target component 240 may present the name and/or summary of the new book.

Further, the target component 240 may include, for example, a reminder control 250. The reminder control 250 may, for example, be used to provide a creation reminder associated with the new book to the creator. For example, the reader-user may trigger sending a reminder for urging the creator to release a new book by clicking the reminder control 250. Such a creation reminder may also be indicated, for example, by the number of reminders presented in the reminder control 250, which may represent, for example, the number of times the reminder control 250 is selected by the reader-user, or the user number of the reader-user who clicked the reminder control 250.

Additionally, the target component 240 may also include, for example, a subscription control 250 for subscribing to the unreleased new book. For example, in a scenario where the reader-user clicks the subscription control 255, if the new book is published, then the new book may be automatically added to the book list associated with the reader-user. The book list may include a set of released books added by the reader-user, taking the scenario of electronic books as an example, the book list may also be referred to as a “bookshelf”. Similar to the reminder control 250, the subscription control 255 may also indicate, for example, the user number of the reader user who have subscribed to the of the new book.

Using FIG. 2D as an example, interface 200C shows an interface associated with the reader-user. In a scenario where the reader-user subscribed to the new book 265 through the subscription control 255, if the new book 265 is released, the new book may be automatically added to the reader-user's bookshelf 260, for example, to facilitate the reader-user to more quickly obtain the new book 265.

Based on such a manner, the embodiments of the present disclosure can support the creator associated with the released book to share a unreleased new book, thereby improving the creation enthusiasm of the creator. In addition, such manner can also facilitate the user to more efficiently obtain the new book of the creator.

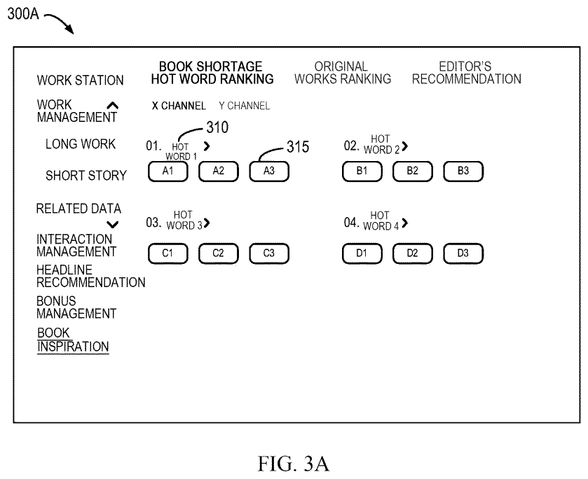

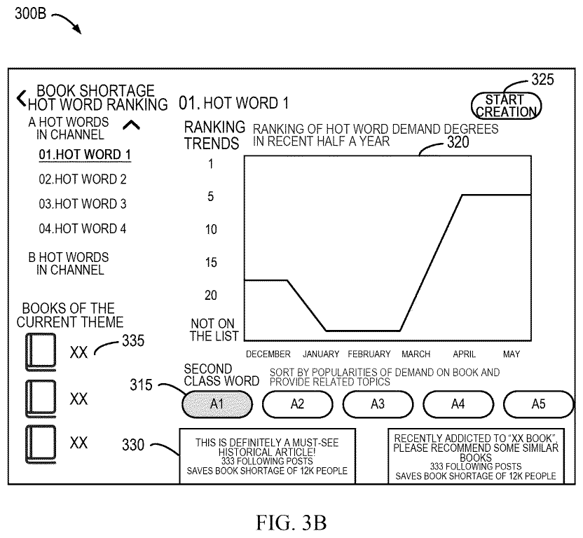

In some embodiments, the terminal device 110 may also provide, for example, an interface for the creator to attach to the book creation, to provide a creation idea for the creator. FIG. 3A illustrates an example interface 300A, in accordance with some embodiments of the present disclosure.

As shown in FIG. 3A, the terminal device 110 may present at least one keyword 310 (also referred to as a first set of keywords) to the creator in the creation guidance interface 300A. Such a first set of keywords 310 may be associated with an creation theme of a book, which may also be referred to as a “hot word”, for example.

In some embodiments, the first set of keywords 310 may be determined based on a set of topic contents associated with the book content. Such topic content may include any suitable topic discussing a book, such as a topic associated with finding the book.

In some embodiments, a set of topic contents associated with the book content may be obtained by an appropriate electronic device (e.g., the server 130 shown in FIG. 1), and keyword associated with the creation theme of the book is determined accordingly.

For example, the server 130 may perform word segmentation processing on a set of topic content to obtain a set of candidate keyword. Further, the server 130 may remove at least one noise word from the set of candidate keywords based on a relevance between the set of candidate keywords and the creation theme of the book.

In some embodiments, the server 130 may obtain a predetermined set of noise words, the set of noise words comprising a plurality of keywords indicated to be irrelevant to the creation theme of the book. For example, such a set of noise words may include keyword that are irrelevant to the creation theme of the book, such as “beg” “high score,” and the like.

Further, the server 130 may remove the at least one noise word from the set of candidate keywords that matches the set of noise words. For example, the server may perform filtering of particular noise words to exclude keywords (e.g., “beg” “high scores” etc.) that are not helpful to creation from the set of candidate keywords.

Further, the server 130 may, for example, determine the first set of keywords 310 for assisting in the creation based on a frequency of the set of candidate keywords after removal. For example, the server 130 may determine a predetermined number of keyword with the highest frequency as the first set of keywords 310.

Further, the terminal device 110 may also present the second set of keywords 315 associated with the keyword 310 in association with the first set of keywords 310. Such a second set of keyword words 315 may also be referred to as secondary words, which may likewise be determined based on topic content associated with the book content.

Specifically, the server 130 may extract a second set of keywords 315 associated with the keyword 310 from a plurality of topic contents that matches the keyword 310 (for example, the “hot word 1”), wherein a frequency of co-occurrence of the keyword 310 and the second set of keywords 315 in the plurality of topic contents is higher than a threshold.

For example, the server 130 performs a word segmentation processing on a plurality of topic contents corresponding to a specific keyword 310 (for example, “hot word 1”) to determine a plurality of keywords. Further, the server 130 may determine the second set of keywords 315 associated with the particular keyword 310 based on a frequency at which the plurality of keywords co-occur with the keyword 310.

It should be understood that other appropriate text analysis techniques besides the word segmentation processing may also be used to determine the first set of keywords and the second set of keywords from the topic content associated with the book requirement.

Further, in a scenario where the creator selects the keyword 310 (for example, the hot word 1), the terminal device 110 may further present the interface 300B shown in FIG. 3B.

In the interface 300B, the terminal device 110 may present the popularity information 320 associated with the selected keyword 310. In some embodiments, the popularity information 320 may indicate a change of the popularity of the keyword 310 over a predetermined period.

In some embodiments, the server 130 may, for example, determine the popularity of the keyword 310, with the interaction information of the set of topic contents associated with the keyword 310. For example, such interaction information may include a number of following posts, a number of comments, a number of shares, a number of views of the topic content and the like.

Therefore, the embodiment of the present disclosure can further help the creator know the popularity change of the keyword, so that the creator can conveniently determine the direction of the creation.

In some embodiments, the terminal device 110 may also present the released book 335 associated with the keyword 310 at the creation guidance interface 300B. For example, the terminal device 110 may present other books under the keyword 310 for reference by the creator.

Additionally, the terminal device 110 may also provide topic information 330 corresponding to the keyword 310 and/or the keyword 315 in the creation guidance interface 300B, so that the topic information may be used to indicate topic content matching the keyword 310 and/or the keyword 315.

For example, the topic information 330 may include a title of at least one topic content that matches the keyword 310.

Alternatively or additionally, such topic information 330 may include interaction information of at least one topic content that matches the keyword 310. For example, such interaction information may include participation popularity, a number of participants, a number of following posts, a number of comments, a number of forwarding of the corresponding topic content, and the like.

Alternatively, or additionally, such topic information 330 may also include a picture associated with at least the impact topic content. Such a picture may include, for example, an illustration of the topic content, or a picture of the section to which the topic content belongs, and so on.

Further, the creator may view the topic content associated with the keyword 315 by selecting the keyword 315.

Alternatively, or additionally, the creator may also jump the viewing interface of the topic content corresponding to the topic information 330 by clicking the topic information 330, for example. For example, the creator may browse all the following posts of the corresponding topic content by clicking on the topic information 330.

In some embodiments, as shown in FIG. 3B, the terminal device 110 may further provide a portal 325 in the interface 300B. Upon receiving the selection of the portal 325, the terminal device 110 may provide an interface for the creator to create or release a new book. Further, the new book may be generated based on the interaction of the creator, and in addition, the new book may also be automatically marked as being associated with the selected keyword 310 (e.g., the hot word 1).

In some embodiments, in the scenario where the creator selects the keyword 310 and further creates a new book, the terminal device 110 may, for example, also present the new book guidance interface 200B discussed with reference to FIG. 2B. Further, the terminal device 110 and/or the server 130 may also automatically determine the description information of the book to be released according to the selected keyword 310. For example, the terminal device 110 may automatically add the description content corresponding to the selected keyword 310 in the input control 230.

Through the creation guidance interface introduced above, the embodiments of the present disclosure can provide the creator with the keyword for assisting in creation of the book, and can help the creator know the popularity change of such keyword, thereby better assisting in the creation of the book for the creator.

It should be understood that the specific interface layout, the specific text content, and the specific value shown in the above examples are merely illustrative, and are not intended to constitute a limitation on the present disclosure.

### Example Processes

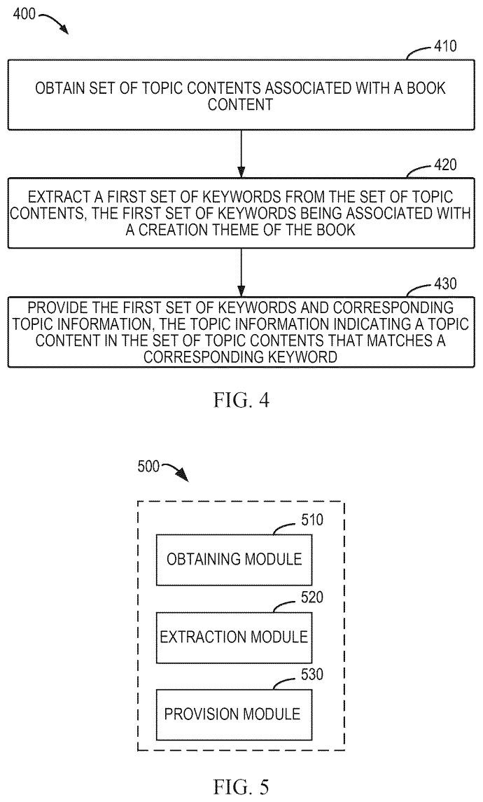

FIG. 4 illustrates a flowchart of a method 400 of assisting in book creation according to some embodiments of the present disclosure. Method 400 may be implemented by a suitable electronic device or combination of electronic devices (e.g., server 130, terminal device 110, or a combination of server 130 and terminal device 110 in FIG. 1). For convenience of description, hereinafter they are collectively referred to as an electronic device, the process 400 is described with reference to FIG. 1.

At block 410, the electronic device obtains a set of topic contents associated with a book content.

At block 420, the electronic device extracts a first set of keywords from the set of topic contents, the first set of keywords being associated with a creation theme of the book.

At block 430, the electronic device provides the first set of keywords and corresponding topic information, the topic information indicating a topic content in the set of topic contents that matches a corresponding keyword.

In some embodiments, extracting a first set of keywords from the set of topic contents comprises: determining a set of candidate keywords based on a word segmentation processing on the set of topic contents; removing at least one noise word from the set of candidate keywords based on a relevance between the set of candidate keywords and the creation theme of the book; and determining the first set of keywords based on a frequency of the set of candidate keywords after removal.

In some embodiments, removing at least one noise word from the set of candidate keywords based on a relevance between the set of candidate keywords and the creation theme of the book comprises: obtaining a predetermined set of noise words, the set of noise words comprising a plurality of keywords indicated to be irrelevant to the creation subject of the book; and removing the at least one noise word from the set of candidate keywords that matches the set of noise words.

In some embodiments, the first set of keywords comprises at least a first keyword, and the method further comprises: extracting a second set of keywords associated with the first keyword from a plurality of topic contents that matches the first keyword, wherein a frequency of co-occurrence of the first keyword and the second set of keywords in the plurality of topic contents is higher than a threshold; and providing the second set of keywords in association with the first keyword.

In some embodiments, the topic information corresponding to a target keyword in the first set of keywords comprises at least one of the following: a title of at least one target topic content matching the target keyword; interaction information of the at least one target topic content; a picture associated with the at least one target topic content.

In some embodiments, the method 400 further comprises: displaying a viewing page of the topic content corresponding to the topic information based on a selection of the topic information.

In some embodiments, the method 400 further comprises: determining a popularity of the first set of keywords based on interaction information of the set of topic contents; and providing popularity information associated with the first set of keywords, the popularity information indicating a change of the popularity of the first set of keywords over a predetermined period.

In some embodiments, the method 400 further comprises: releasing a book associated with a second keyword based on a selection of the second keyword in the first set of keywords by a creator.

In some embodiments, the method 400 further comprises: obtaining description information about a book to be released of a creator; and providing a promotion content associated with the book to be released in a target page associated with the creator based on the description information.

In some embodiments, obtaining description information about a book to be released of a creator comprises: receiving a selection of at least one keyword in the first set of keywords by the creator; and determining the description information about the book to be released based on the at least one selected keyword.

In some embodiments, obtaining description information about a book to be released of a creator comprises: presenting a new book guidance page to the creator in response to a creation content of a released book of the creator exceeding a threshold; and obtaining the description information about the book to be released of the creator via the new book guidance page.

In some embodiments, obtaining description information about a book to be released of a creator comprises: obtaining the description information of the created book based on a selection regarding an unreleased created book by the creator.

In some embodiments, the description information comprises: a name of the book to be released; and/or a summary of the book to be released.

In some embodiments, the target page comprises a viewing page of a released target book of the creator.

In some embodiments, the target book is determined from a set of books released by the creator based on a predetermined condition, and the predetermined condition comprises a completion status of a book and/or an amount of created content of a book.

### Example Apparatus and Apparatus

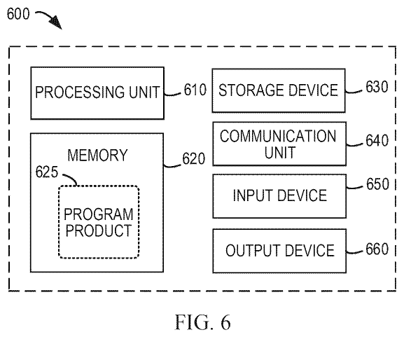

FIG. 5 illustrates a schematic structural block diagram of an apparatus 500 for assisting in book creation according to some embodiments of the present disclosure. The apparatus 500 may be implemented or included in a suitable electronic device or combination of electronic devices (e.g., the server 130, the terminal device 110, or a combination of the server 130 and the terminal device 110 in FIG. 1). The various modules/components in the apparatus 500 may be implemented by hardware, software, firmware, or any combination thereof.

As shown, the apparatus 500 comprises an obtaining module 510, configured to obtain a set of topic contents associated with a book content; an extraction module 520, configured to extract a first set of keywords from the set of topic contents, the first set of keywords being associated with a creation theme of the book; and a provision module 530, configured to provide the first set of keywords and corresponding topic information, the topic information indicating a topic content in the set of topic contents that matches a corresponding keyword.

In some embodiments, the extraction module 520 is further configured to: determine a set of candidate keywords based on a word segmentation processing on the set of topic contents; remove at least one noise word from the set of candidate keywords based on a relevance between the set of candidate keywords and the creation theme of the book; and determine the first set of keywords based on a frequency of the set of candidate keywords after removal.

In some embodiments, the extraction module 520 is further configured to: obtain a predetermined set of noise words, the set of noise words comprising a plurality of keywords indicated to be irrelevant to the creation subject of the book; and removing the at least one noise word from the set of candidate keywords that matches the set of noise words.

In some embodiments, the first set of keywords comprises at least a first keyword, and the apparatus 500 further comprises a keyword provision module configured to: extract a second set of keywords associated with the first keyword from a plurality of topic contents that matches the first keyword, wherein a frequency of co-occurrence of the first keyword and the second set of keywords in the plurality of topic contents is higher than a threshold; and provide the second set of keywords in association with the first keyword.

In some embodiments, the topic information corresponding to a target keyword in the first set of keywords comprises at least one of the following: a title of at least one target topic content matching the target keyword; interaction information of the at least one target topic content; a picture associated with the at least one target topic content.

In some embodiments, the apparatus 500 further comprises a display module configured to display a viewing page of the topic content corresponding to the topic information based on a selection of the topic information.

In some embodiments, the apparatus 500 further comprises a popularity module configured to: determine a popularity of the first set of keywords based on interaction information of the set of topic contents; and provide popularity information associated with the first set of keywords, the popularity information indicating a change of the popularity of the first set of keywords over a predetermined period.

In some embodiments, the apparatus 500 further comprises a releasing module configured to release a book associated with a second keyword based on a selection of the second keyword in the first set of keywords by a creator.

In some embodiments, the apparatus 500 further comprises a promotion module configured to: obtain description information about a book to be released of a creator; and provide a promotion content associated with the book to be released in a target page associated with the creator based on the description information.

In some embodiments, the promotion module is further configured to: receive a selection of at least one keyword in the first set of keywords by the creator; and determine the description information about the book to be released based on the at least one selected keyword.

In some embodiments, the promotion module is further configured to: present a new book guidance page to the creator in response to a creation content of a released book of the creator exceeding a threshold; and obtain the description information about the book to be released of the creator via the new book guidance page.

In some embodiments, the promotion module is further configured to: obtain the description information of the created book based on a selection regarding an unreleased created book by the creator.

In some embodiments, the description information comprises: a name of the book to be released; and/or a summary of the book to be released.

In some embodiments, the target page comprises a viewing page of a released target book of the creator.

In some embodiments, the target book is determined from a set of books released by the creator based on a predetermined condition, and the predetermined condition comprises a completion status of a book and/or an amount of created content of a book.

FIG. 6 illustrates a block diagram illustrating an electronic device 600 in which one or more embodiments of the present disclosure may be implemented. It should be understood that the electronic device 600 illustrated in FIG. 6 is merely illustrative and should not constitute any limitation on the functionality and scope of the embodiments described herein. The electronic device 600 shown in FIG. 6 may be configured to implement the server 130, the terminal device 110, or a combination of the server 130 and the terminal device 110 in FIG. 1.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor system, multiple processing units execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data (e.g., training data for training) and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or a plurality of computing machines capable of communicating over a communication connection. Thus, the electronic device 600 may operate in a networked environment using logical connections with one or more other servers, network personal computers (PCs), or another network Node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/actions specified in the flowchart and/or block diagram(s).

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, and the above description is illustrative, not exhaustive, and is not limited to the disclosed implementations. Many modifications and variations will be apparent to those of ordinary skill in the art without departing from the scope and spirit of the illustrated implementations. The selection of the terms used herein is intended to best explain the principles of the implementations, practical applications, or improvements to techniques in the marketplace, or to enable others of ordinary skill in the art to understand the various implementations disclosed herein.

I/we claim:

1. A method of assisting in book creation, comprising:
obtaining a set of topic contents associated with a book content;
extracting a first set of keywords from the set of topic contents, the first set of keywords being associated with a creation theme of the book; and
providing the first set of keywords and corresponding topic information, the topic information indicating a topic content in the set of topic contents that matches a corresponding keyword.

2. The method of claim 1, wherein extracting a first set of keywords from the set of topic contents comprises:
determining a set of candidate keywords based on a word segmentation processing on the set of topic contents;
removing at least one noise word from the set of candidate keywords based on a relevance between the set of candidate keywords and the creation theme of the book; and
determining the first set of keywords based on a frequency of the set of candidate keywords after removal.

3. The method of claim 2, wherein removing at least one noise word from the set of candidate keywords based on a relevance between the set of candidate keywords and the creation theme of the book comprises:
obtaining a predetermined set of noise words, the set of noise words comprising a plurality of keywords indicated to be irrelevant to the creation theme of the book; and
removing the at least one noise word from the set of candidate keywords that matches the set of noise words.

4. The method of claim 1, wherein the first set of keywords comprises at least a first keyword, and the method further comprises:
extracting a second set of keywords associated with the first keyword from a plurality of topic contents that matches the first keyword, wherein a frequency of co-occurrence of the first keyword and the second set of keywords in the plurality of topic contents is higher than a threshold; and
providing the second set of keywords in association with the first keyword.

5. The method of claim 1, wherein the topic information corresponding to a target keyword in the first set of keywords comprises at least one of the following:
a title of at least one target topic content matching the target keyword;
interaction information of the at least one target topic content;
a picture associated with the at least one target topic content.

6. The method of claim 1, further comprising:
displaying a viewing page of the topic content corresponding to the topic information based on a selection of the topic information.

7. The method of claim 1, further comprising:
determining a popularity of the first set of keywords based on interaction information of the set of topic contents; and
providing popularity information associated with the first set of keywords, the popularity information indicating a change of the popularity of the first set of keywords over a predetermined period.

8. The method of claim 1, further comprising:
releasing a book associated with a second keyword based on a selection of the second keyword in the first set of keywords by a creator.

9. The method of claim 1, further comprising:
obtaining description information about a book to be released of a creator; and
providing a promotion content associated with the book to be released in a target page associated with the creator based on the description information.

10. The method of claim 9, wherein obtaining description information about a book to be released of a creator comprises:
receiving a selection of at least one keyword in the first set of keywords by the creator; and
determining the description information about the book to be released based on the at least one selected keyword.

11. The method of claim 9, wherein obtaining description information about a book to be released of a creator comprises:
presenting a new book guidance page to the creator in response to a creation content of a released book of the creator exceeding a threshold; and
obtaining the description information about the book to be released of the creator via the new book guidance page.

12. The method of claim 9, wherein obtaining description information about a book to be released of a creator comprises:
obtaining the description information of the created book based on a selection regarding an unreleased created book by the creator.

13. The method of claim 9, wherein the description information comprises:
a name of the book to be released; and/or
a summary of the book to be released.

14. The method of claim 9, wherein the target page comprises a viewing page of a released target book of the creator.

15. The method of claim 14, wherein the target book is determined from a set of books released by the creator based on a predetermined condition, and the predetermined condition comprises a completion status of a book and/or an amount of created content of a book.

16. An electronic device, comprising:
at least one processing unit; and
at least one memory coupled to the at least one processing unit and storing instructions for execution by the at least one processing unit, the instructions, when executed by the at least one processing unit, causing the electronic device to perform at least:
obtaining a set of topic contents associated with a book content;
extracting a first set of keywords from the set of topic contents, the first set of keywords being associated with a creation theme of the book; and
providing the first set of keywords and corresponding topic information, the topic information indicating a topic content in the set of topic contents that matches a corresponding keyword.

17. The electronic device of claim 16, wherein extracting a first set of keywords from the set of topic contents comprises:
determining a set of candidate keywords based on a word segmentation processing on the set of topic contents;
removing at least one noise word from the set of candidate keywords based on a relevance between the set of candidate keywords and the creation theme of the book; and
determining the first set of keywords based on a frequency of the set of candidate keywords after removal.

18. The electronic device of claim 17, wherein removing at least one noise word from the set of candidate keywords based on a relevance between the set of candidate keywords and the creation theme of the book comprises:
obtaining a predetermined set of noise words, the set of noise words comprising a plurality of keywords indicated to be irrelevant to the creation theme of the book; and
removing the at least one noise word from the set of candidate keywords that matches the set of noise words.

19. The electronic device of claim 16, wherein the first set of keywords comprises at least a first keyword, and the method further comprises:
extracting a second set of keywords associated with the first keyword from a plurality of topic contents that matches the first keyword, wherein a frequency of co-occurrence of the first keyword and the second set of keywords in the plurality of topic contents is higher than a threshold; and
providing the second set of keywords in association with the first keyword.

20. A non-transitory computer-readable storage medium having a computer program stored thereon, the computer program being executable by a processor to implement a method comprising:
obtaining a set of topic contents associated with a book content;
extracting a first set of keywords from the set of topic contents, the first set of keywords being associated with a creation theme of the book; and
providing the first set of keywords and corresponding topic information, the topic information indicating a topic content in the set of topic contents that matches a corresponding keyword.
